(19) United States
(12) Patent Application Publication
(10) Pub. No.: US 2020/0201680 A1
(43) Pub. Date: Jun. 25, 2020

(54) SYSTEM, METHOD, AND COMPUTER-READABLE MEDIUM FOR ITERATIVELY DYNAMICALLY ASSIGNING DATA OBJECTS TO A PLURALITY OF PROCESSING MODULES OF A DATABASE SYSTEM

(71) Applicant: Teradata US, Inc., Dayton, OH (US)

(72) Inventors: Michael Warren Watzke, Fitchburg, WI (US); Steven B. Cohen, Redondo Beach, CA (US); Donald Raymond Pederson, San Diego, CA (US)

(73) Assignee: Teradata US, Inc., Dayton, OH (US)

(21) Appl. No.: 16/224,851

(22) Filed: Dec. 19, 2018

(51) Int. Cl. G06F 9/50; G06F 9/455; G06F 9/48; G06F 16/2455; G06F 16/2453

(52) U.S. Cl. CPC G06F 9/505; G06F 9/45558; G06F 2009/4557; G06F 16/2456; G06F 16/2453; G06F 9/4856

(57) ABSTRACT

A database system comprises a plurality of processing modules arranged to process data objects from a plurality of data object servers based upon a database query from a client computer system. A control task module is arranged to iteratively dynamically assign data objects from the plurality of data object servers to each of the plurality of processing modules based upon processing activity associated with the processing module during the database query from the client computer system. Alternatively, or in addition to, the control task module is arranged to iteratively dynamically assign data objects from the plurality of data object servers to each of the plurality of processing modules based upon a characteristic of the data objects to be dynamically assigned to the processing module during the database query from the client computer system.

### TECHNICAL FIELD

The present disclosure relates to optimization of database queries to improve performance of a database system, and is particularly directed to a system, method, and computer-readable medium for iteratively dynamically assigning data objects to a plurality of processing modules of a database system.

### BACKGROUND

A database is a collection of stored data that is logically related and that is accessible by one or more users or applications. A popular type of database system is the relational database management system in which information is represented in the form of relational tables, also referred to as relations, made up of rows and columns (also referred to as tuples and attributes). Each row represents an occurrence of an entity defined by a table, with an entity being a person, place, thing, or other object about which the table contains information.

Another popular type of database system is the object database management system in which information is represented in the form of objects as used in object-oriented programming. Stored data objects can have a wide range of varying attributes, such as object byte size, data compression effectiveness, and data ingest rates. Object database systems are object-oriented, whereas relational database systems are table-oriented.

One of the goals of a database management system is to optimize the performance of database queries for access and manipulation of data stored in the database system. Given a target environment, an optimal query plan is selected, with the optimal query plan being the one with the lowest cost (e.g., response time) as determined by an optimizer. The response time is the amount of time it takes to complete the execution of a database query on a given database system.

In known database systems that can support object storage subsystems, data objects stored in data object servers are pre-assigned to a plurality of processing modules when a database query is received. The plurality of processing modules is connected in parallel to provide a parallel query engine. Each processing module processes its pre-assigned data objects, and has no control over organization or demographics of the data objects.

Since each processing module has no control over organization or demographics of the data objects assigned to it, performance issues (e.g., data skew, selection skew, join skew, and central processing unit skew) are magnified for the parallel query engine. Moreover, since data objects can have a wide range of varying attributes, data sharing complexities are created for the parallel query engine, especially when the parallel query engine is required to shard data objects at query time or metadata definition time. It would be desirable to overcome performance drawbacks of known parallel query engines of database systems.

### SUMMARY

Disclosed embodiments provide a system, method, and computer-readable medium for iteratively dynamically assigning data objects to a plurality of processing modules of a database system to improve performance of the database system. A database query is received from a client computer system. Data objects are iteratively dynamically assigned from a plurality of data object servers to each processing module based upon a select one of (i) processing activity of the processing module, and (ii) a characteristic of the data objects to be dynamically assigned to the processing module.

### BRIEF DESCRIPTION OF THE DRAWINGS

Aspects of the present disclosure are best understood from the following detailed description when read with the accompanying figures, in which:

FIG. 1 depicts a diagrammatic representation of an exemplary architecture for a large database system that is suited for implementing iteratively dynamically-assigned data objects in accordance with disclosed embodiments.

FIG. 2 is a diagrammatic representation of a parsing engine implemented in accordance with an embodiment.

FIG. 3 is a diagrammatic representation of parser processing implemented in accordance with an embodiment.

FIG. 4 is a flowchart that depicts operation of an example control task module that facilitates performance enhancement in a database system in accordance with an embodiment.

FIG. 5 is a flowchart that depicts operation of an example processing module that communicates with the control task module of FIG. 4.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

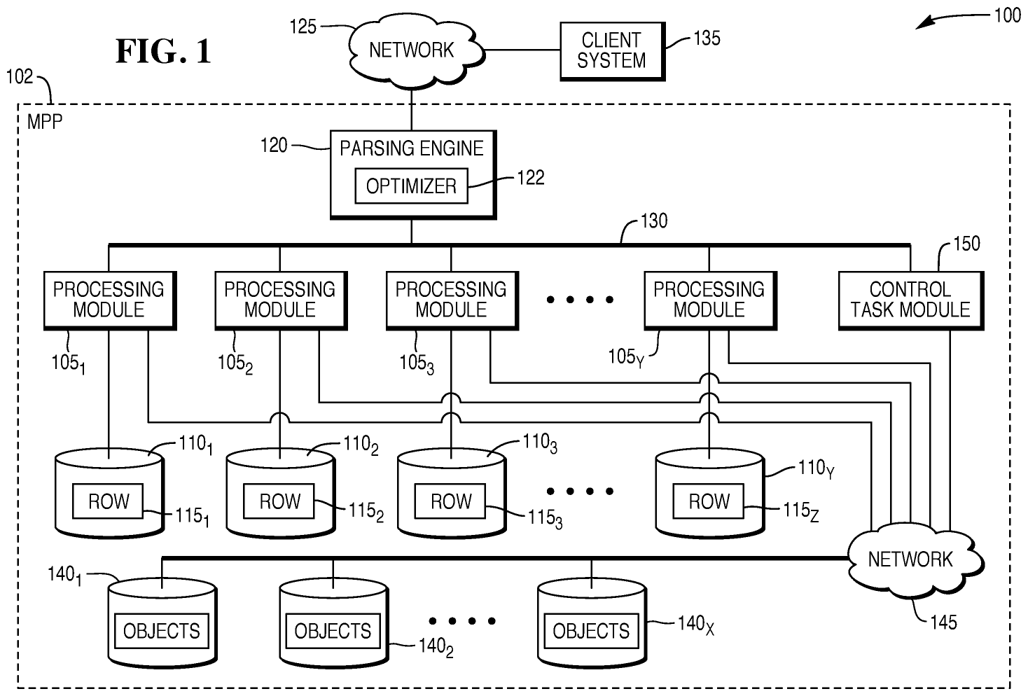

FIG. 1 depicts a diagrammatic representation of an exemplary architecture for a large database system 100, such as a Teradata Active Data Warehousing System, that is suited for implementing iteratively dynamically-assigned data objects in accordance with disclosed embodiments. The database system 100 includes a relational database management system (RDBMS) built upon a massive parallel processing (MPP) system 102. Other types of database systems, such as object-relational database management systems (ORDBMS) or those built on symmetric multi-processing (SMP) platforms, are also suited for use. The depicted and described architecture is exemplary only and is chosen to facilitate an understanding of the disclosed embodiments.

As shown, the database system 100 includes one or more processing modules 105_{1 . . . Y} that manage the storage and retrieval of data in data-storage facilities 110_{1 . . . Y}. Each of the processing modules 105_{1 . . . Y} may be one or more physical processors or each may be a virtual processor, such as an Access Module Processor (AMP), with one or more virtual processors running on one or more physical processors. For the case in which one or more virtual processors are running on a single physical processor, the single physical processor swaps between the set of virtual processors. For the case in which N virtual processors are running on an M-processor node, the node's operating system schedules the N virtual processors to run on its set of M physical processors. Each of the processing modules 105_{1 . . . Y} manages a portion of a database that is stored in corresponding data-storage facilities 110_{1 . . . Y}. Each of the data-storage facilities 110_{1 . . . Y} includes one or more disk drives or other storage medium.

The database system 100 stores data in one or more tables in the data-storage facilities 110_{1 . . . Y}. The rows 115_{1 . . . Z} of the tables are stored across multiple data-storage facilities 110_{1 . . . Y} to ensure that the system workload is distributed evenly across the processing modules 105_{1 . . . Y}. A parsing engine 120 organizes the storage of data and the distribution of table rows 115_{1 . . . Z} among the processing modules 105_{1 . . . Y} and accesses processing modules 105_{1 . . . Y} via an interconnect 130. The parsing engine 120 also coordinates the retrieval of data from the data-storage facilities 110_{1 . . . Y} in response to queries received from a user, such as one using a client computer system 135 connected to the database system 100 through a communications network connection 125. The database system 100 typically receives queries in a standard format, such as the Structured Query Language (SQL) put forth by the American National Standards Institute (ANSI).

Each of the processing modules 105_{1 . . . Y} is also connected through a communications network connection 145 to an object storage subsystem that includes a number of data object servers 140_{1 . . . X}. Each of the data object servers 140_{1 . . . X} includes one or more disk drives or other storage medium. Each of the data object servers 140_{1 . . . X} stores one or more data objects (i.e., an object store).

The parsing engine 120, on receiving an incoming database query, applies an optimizer component 122 to the query to assess the best plan for execution of the query. Selecting the optimal query-execution plan includes, among other things, identifying which of the processing modules 105_{1 . . . Y} are involved in executing the query and which database tables are involved in the query, as well as choosing which data-manipulation techniques will serve best in satisfying the conditions of the query. Database statistics are used in making these assessments during construction of the query-execution plan. For example, database statistics may be used by the optimizer to determine data demographics, such as attribute minimum and maximum values and data ranges of the database.

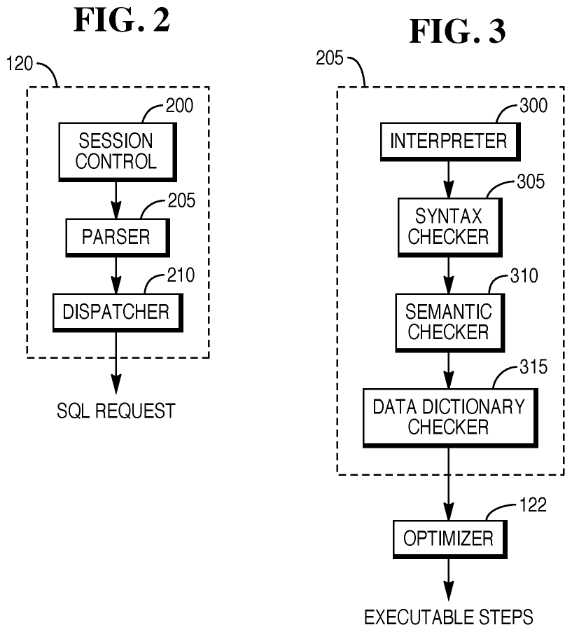

In one example system, the parsing engine 120 is made up of three components: a session control 200, a parser 205, and a dispatcher 210, as shown in FIG. 2. The session control 200 provides the logon and logoff function. It accepts a request for authorization to access the database, verifies it, and then either allows or disallows the access. Once the session control 200 allows a session to begin, a user may submit a SQL request that is routed to the parser 205. As illustrated in FIG. 3, the parser 205 interprets the SQL request (block 300), checks the request for correct SQL syntax (block 305), evaluates the request semantically (block 310), and consults a data dictionary to ensure that all of the objects specified in the SQL request exist and that the user has the authority to perform the request (block 315). Finally, the parser 205 runs the optimizer 122 that selects the least expensive plan to perform the request.

In accordance with an aspect of the present disclosure, a control task module 150 is connected through the communications network connection 145 to the data object servers 140_{1 . . . X}. Although the control task module 150 is shown in FIG. 1 as being separate from the plurality of processing modules 105_{1 . . . Y}, it is conceivable that the control task module 150 can arbitrarily comprise a portion of one of the plurality of processing modules 105_{1 . . . Y}. The control task module 150 hands out data objects to the processing modules 105_{1 . . . Y}, as will be described herein, to improve performance of the database system 100.

When a database query is received from the client computer system 135, the control task module 150 dynamically assigns data objects to the processing modules 105_{1 . . . Y}. More specifically, the control task module 150 is arranged to iteratively dynamically assign data objects from the data object servers 140_{1 . . . X} to each processing module of the plurality of processing modules 105_{1 . . . Y} based upon a select one of (i) processing activity of the processing module, and (ii) a characteristic of the data objects to be dynamically assigned to the processing module.

The iterative dynamic assigning of data objects is performed incrementally, and is embedded in the database query. The result is smaller chunks of unit-of-work being handed out to each of the processing modules 105_{1 . . . Y} during the data pipeline flow of the particular database query. As such, the database query is being enhanced or optimized based upon performance of the control task module 150.

In some embodiments, the processing activity of each processing module during the database query comprises random processing activity associated with the processing module. In some embodiments, the processing activity of each processing module during the database query comprises a number of output rows being generated by the processing module. As an example, if a requesting processing module has an output record count of about 300,000 while each of the other processing modules has an output record count of only about 100,000, then the requesting processing module is placed in a message wait queue until the output record count of each of the other processing modules becomes more equal to the output record count of the requesting processing module.

In some embodiments, the characteristic of the data objects to be dynamically assigned to the processing module comprises size of one or more data objects to be assigned to the processing module. In some embodiments, the characteristic of the data objects to be dynamically assigned to the processing module comprises a collection of small batches of data objects to be dynamically assigned to the processing module.

In some embodiments, the data objects are dynamically assigned from the plurality of data object servers 140_{1 . . . X} to each processing module based upon both processing activity of the processing module and a characteristic of the data objects to be dynamically assigned to the processing module.

In some embodiments, data objects from a processing module that is unable to process its assigned data objects are dynamically reassigned to remaining processing modules so that the remaining processing modules can process the reassigned data objects. In some embodiments, data objects are reassigned to a processing module based upon processing speed of the processing module to which the data objects are reassigned. In some embodiments, data objects are dynamically reassigned to a processing module based upon a determination that the processing module from which data objects are being reassigned is classified as a straggler.

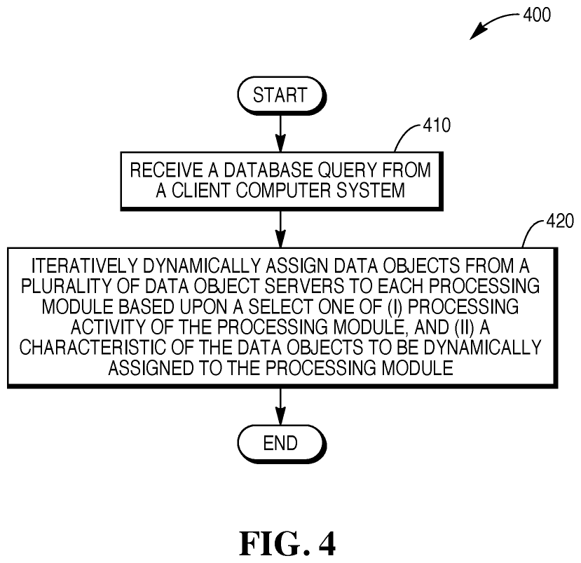

FIG. 4 is a flowchart 400 that depicts operation of an example control task module that facilitates performance enhancement in a database system in accordance with an embodiment. In particular, data objects are iteratively dynamically assigned to a plurality of processing modules of a database system to improve performance of the database system. The processing blocks of FIG. 4 may be implemented as computer-executable instructions tangibly embodied on a computer-readable medium executable by a processing system, such as the control task module 150 depicted in FIG. 1.

In block 410, a database query is received from a client computer system. Then, in block 420, data objects are iteratively dynamically assigned from a plurality of data object servers to each processing module based upon a select one of (i) processing activity of the processing module, and (ii) a characteristic of the data objects to be dynamically assigned to the processing module. The process then ends.

In some embodiments, a database query involving execution of a join operator is received. As an example, the join operator may involve joining one or more objects stored in data object servers and one or more objects stored in the native database system.

In some embodiments, data objects are iteratively dynamically assigned from a plurality of data object servers to each processing module based upon both processing activity of the processing module and a characteristic of the data objects to be dynamically assigned to the processing module.

In some embodiments, data objects are iteratively dynamically assigned from a plurality of data object servers to each processing module based upon a number of output rows being generated by the processing module.

In some embodiments, data objects are iteratively dynamically assigned from a plurality of data object servers to each processing module based upon size of one or more data objects to be dynamically assigned to the processing module.

In some embodiments, the method further comprises dynamically reassigning data objects from a processing module that is unable to process its assigned data objects to remaining processing modules so that the remaining processing modules can process the reassigned data objects. In some embodiments, data objects are dynamically reassigned to a processing module based upon processing speed of the processing module to which the data objects are reassigned. In some embodiments, data objects are dynamically reassigned to a processing module based upon a determination that the processing module from which data objects are being reassigned is classified as a straggler.

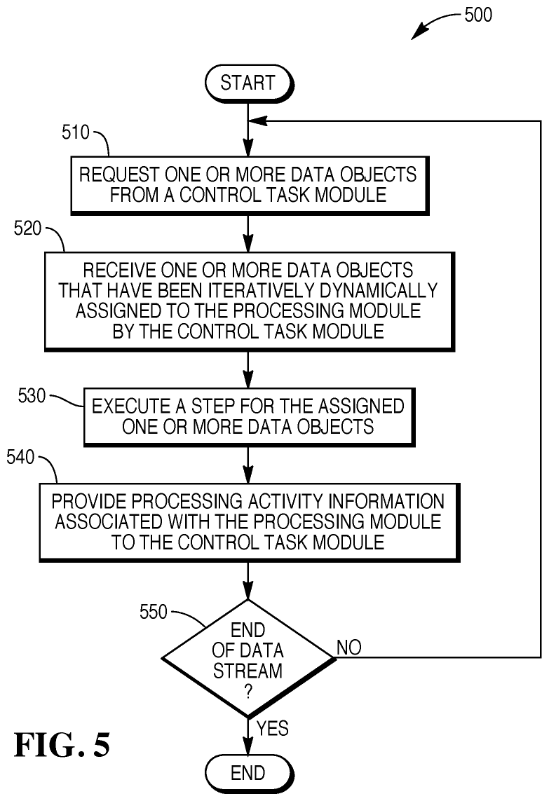

FIG. 5 is a flowchart 500 that depicts operation of an example processing module that communicates with the control task module of FIG. 4. In particular, the processing module iteratively processes data objects for a database query. In block 510, the processing module requests one or more data objects from the control task module. The processing module receives one or more data objects that have been iteratively dynamically assigned to the processing module by the control task module, as shown in block 520. Then, in block 530, the processing module executes a step for the assigned one or more data objects. The process proceeds to block 540 in which processing activity information (e.g., current processing statistics, and current row count) associated with the processing module is provided to the control task module. The process then proceeds to block 550.

In block 550, a determination is made as to whether data stream associated with the database query has ended. If the determination in block 550 is negative (i.e., the data stream has not ended), the process returns back to block 510 to repeat requesting of data objects from the control task module and providing processing activity information to the control task module until end of data stream associated with the database query is reached. When the determination in block 550 is affirmative (i.e., the data stream has ended), the process ends.

It should be apparent that the above description describes the control task module 150 dynamically monitoring the execution pipeline during a database query and iteratively dynamically adjusting the assignment of data objects to the processing modules 105_{1 . . . Y} based upon a number of different factors. These factors include, but not limited to, data object size, output record counts, processing speed, object store input/output latency, failed processing modules, and stragglers. In the case of stragglers or failed processing modules, there is no need to steal and/or shed shards since data objects were not pre-assigned. Object store input/output latency is related to processing speed, and is usually greater than (and can vary more than) local data storage.

It should be apparent that the control task module 150 iteratively dynamically adapts to all forms of processing skew including, but not limited to, join skew, aggregation/reduce skew, selection/filter skew, and complex analytical functions skew. Moreover, the control task module 150 cooperates with the parsing engine 120 to support filtering shards based upon the particular query format.

It should also be apparent that the above-described control task module 150 supports object storage subsystems in addition to local block-oriented storage. The control task module 150 may be implemented in any type of database system. Moreover, the object can be a specific object or a part of the object that is addressable without reading the whole object. The object can be a full object or a part of the object if the object can be split into multiple addressable parts (e.g., Parquet and row groups). Accordingly, it is conceivable that only part of a data object can be iteratively dynamically assigned by the control task module 150.

It should further be apparent that the above description describes query optimization methods, computer-readable media, and systems that facilitate performance enhancement of a database system. The query optimization methods, media, and systems are applicable to a wide variety of queries, such as a join type of query. Other types of queries which can be optimized are possible.

Each of the above-described flowcharts depicts process serialization to facilitate an understanding of disclosed embodiments and is not necessarily indicative of the serialization of the operations being performed. In various embodiments, the processing steps described in each of the flowcharts above may be performed in varying order, and one or more depicted steps may be performed in parallel with other steps. Additionally, execution of some processing steps of each of the flowcharts above may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer. The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information. Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

What is claimed is:

1. A database system comprising:
a plurality of processing modules arranged to process data objects from a plurality of data object servers based upon a database query from a client computer system; and
a control task module arranged to iteratively dynamically assign data objects from the plurality of data object servers to each of the plurality of processing modules based upon processing activity associated with the processing module during the database query from the client computer system.

2. A database system according to claim 1, wherein the control task module comprises a portion of one of the plurality of processing modules.

3. A database system according to claim 1 further comprising:
a first communications network connected between the client computer system and each module; and
a second communications network connected between the plurality of data object servers and each module.

4. A database system according to claim 1, wherein processing activity of each processing module during the database query comprises a number of output rows being generated by the processing module.

5. A database system according to claim 1, wherein processing activity of each processing module during the database query comprises random processing activity associated with the processing module.

6. A database system comprising:
a plurality of processing modules arranged to process data objects from a plurality of data object servers based upon a database query from a client computer system; and
a control task module arranged to iteratively dynamically assign data objects from the plurality of data object servers to each of the plurality of processing modules based upon a characteristic of the data objects to be dynamically assigned to the processing module during the database query from the client computer system.

7. A database system according to claim 6, wherein the control task module comprises a portion of one of the plurality of processing modules.

8. A database system according to claim 6 further comprising:
a first communications network connected between the client computer system and each module; and
a second communications network connected between the plurality of data object servers and each module.

9. A database system according to claim 6, wherein the characteristic of the data objects to be dynamically assigned to the processing module comprises size of one or more data objects to be assigned to the processing module.

10. A database system according to claim 6, wherein the characteristic of the data objects to be dynamically assigned to the processing module comprises a collection of small batches of data objects to be dynamically assigned to the processing module.

11. A method for assigning data objects to a plurality of processing modules of a database system to improve performance of the database system, the method comprising:
receiving a database query from a client computer system; and
iteratively dynamically assigning data objects from a plurality of data object servers to each processing module based upon a select one of (i) processing activity of the processing module, and (ii) a characteristic of the data objects to be dynamically assigned to the processing module.

12. A method according to claim 11, wherein receiving a database query from a client computer system includes:
receiving a database query involving execution of a join operator.

13. A method according to claim 11, wherein iteratively dynamically assigning data objects from a plurality of data object servers to each processing module based upon a select one of (i) processing activity of the processing module, and (ii) a characteristic of the data objects to be dynamically assigned to the processing module includes:
iteratively dynamically assigning data objects from a plurality of data object servers to each processing module based upon both processing activity of the processing module and a characteristic of the data objects to be dynamically assigned to the processing module.

14. A method according to claim 11, wherein iteratively dynamically assigning data objects from a plurality of data object servers to each processing module based upon a select one of (i) processing activity of the processing module, and (ii) a characteristic of the data objects to be dynamically assigned to the processing module includes:
iteratively dynamically assigning data objects from a plurality of data object servers to each processing module based upon a number of output rows being generated by the processing module.

15. A method according to claim 11, wherein iteratively dynamically assigning data objects from a plurality of data object servers to each processing module based upon a select one of (i) processing activity of the processing module, and (ii) a characteristic of the data objects to be dynamically assigned to the processing module includes:
iteratively dynamically assigning data objects from a plurality of data object servers to each processing module based upon size of one or more data objects to be dynamically assigned to the processing module.

16. A method according to claim 11 further comprising:
dynamically reassigning data objects from a processing module that is unable to process its assigned data objects to remaining processing modules so that the remaining processing modules can process the reassigned data objects.

17. A method according to claim 16, wherein dynamically reassigning data objects from a processing module that is unable to process its assigned data objects to remaining processing modules so that the remaining processing modules can process the reassigned data objects includes:
dynamically reassigning data objects to a processing module based upon processing speed of the processing module to which the data objects are reassigned.

18. A method according to claim 16, wherein dynamically reassigning data objects from a processing module that is unable to process its assigned data objects to remaining processing modules so that the remaining processing modules can process the reassigned data objects includes:
dynamically reassigning data objects to a processing module based upon a determination that the processing module from which data objects are being reassigned is classified as a straggler.

19. A method according to claim 11, wherein the method is performed by a computer having a memory executing one or more program of instructions which are tangibly embodied in a storage medium readable by the computer.

20. A method for a processing module iteratively processing data objects based upon a database query, the method comprising:
requesting one or more data objects from a control task module;
receiving one or more data objects that have been iteratively dynamically assigned to the processing module by the control task module;
executing a step for the assigned one or more data objects;
providing processing activity information associated with the processing module to the control task module; and
repeating requesting of data objects from the control task module and providing processing activity information to the control task module until end of data stream associated with the database query.

21. A method according to claim 20, wherein receiving one or more data objects that have been iteratively dynamically assigned to the processing module by the control task module includes:
receiving only a part of a data object that is addressable without reading the whole object.
